(19) United States
(12) Patent Application Publication
(10) Pub. No.: US 2026/0191362 A1
(43) Pub. Date: Jul. 9, 2026

(54) HEATING SPOON

(71) Applicant: Qunzhen Wu, Gaozhou (CN)

(72) Inventor: Qunzhen Wu, Gaozhou (CN)

(21) Appl. No.: 19/557,408

(22) Filed: Mar. 5, 2026

(30) Foreign Application Priority Data
Feb. 11, 2026 (CN) 202620204933.0

(51) Int. Cl. A47J 43/28; A47G 21/04; H05B 3/06

(52) U.S. Cl. CPC A47J 43/282; A47G 21/04; H05B 3/06; H05B 2203/03

(57) ABSTRACT

This application provides a heating spoon including a handle and a spoon body; the handle includes a front end region, a middle portion, and a rear end region; the rear end region is a free end; the front end region, the middle portion, and the rear end region are sequentially arranged to cooperatively form the handle. The spoon body includes a connecting portion, a heating unit, and a heat-conducting portion. The connecting portion and the front end region are oppositely disposed; the connecting portion and the front end region are detachably connected; the heating unit is disposed on a side of the connecting portion away from the front end region; the heating unit and the main circuit assembly are electrically connected; the connecting portion, the heating unit, and the heat-conducting portion are sequentially disposed; the heat-conducting portion is configured to receive thermal energy generated by the heating unit.

### CROSS-REFERENCE TO RELATED APPLICATIONS

This application claims priority to Chinese Patent Application No. 202620204933.0, filed on Feb. 11, 2026, which is hereby incorporated by reference in its entirety.

### TECHNICAL FIELD

This application relates to the technical field of spoons, and in particular, relates to a heating spoon.

### BACKGROUND

In the field of cooking, a wide variety of tableware ensures the convenience and safety of people's dining; as a type of tableware, a spoon has become a tool for holding liquid food, soup, and other food, and has also become indispensable tableware on the daily dining table.

With the diversification of people's eating habits, people pursue more diversified functions for spoons; a spoon not only serves as tableware for holding food, but also undertakes more usage scenarios. For example, it is frequently used when feeding children; children's appetite is relatively variable and they have not developed good eating habits, resulting in food remaining on the spoon easily becoming cold; consuming cold food affects children's bodies to a certain extent. In addition, it is relatively difficult to use a spoon to scoop ice cream, frozen milk, and frozen milkshake foods.

Based on the aforementioned application scenarios, the inventor has discovered a technology that provides a heatable spoon, including a handle, a spoon, and a heating device; the spoon is connected to one end of the handle; the heating device is disposed between the handle and the spoon; the heating device includes a heating pad, a circuit board, a switch touch panel, a display screen, a temperature regulator, a chargeable battery, and a charging interface; the heating pad and the circuit board are disposed within the spoon; the switch touch panel, the display screen, the temperature regulator, the chargeable battery, and the charging interface are disposed within the handle; the heating pad, the switch touch panel, the display screen, the temperature regulator, and the chargeable battery are electrically connected to the circuit board.

The inventor has discovered a technology that provides a heatable spoon, including a handle; a bowl is connected to the handle; a heating element is disposed within the bowl; and a power element is disposed within the handle; the power element is electrically connected to the heating element and supplies power to the heating element.

However, according to the inventor's investigation, the above technologies indeed solve the technical problem of heating a conventional spoon, but with the use of the heating spoon, objectively new technical problems arise in the aforementioned heating spoons; for example, during cleaning of the heating spoon with water, due to the relatively complex circuit structure designed inside the heating spoon, if the waterproof performance of the heating spoon is poor, water residue is easy to penetrate into the circuit structure of the heating spoon, resulting in damage to the heating spoon and posing safety hazards to the human body; furthermore, based on different usage scenarios, people wish to replace different heating spoon bodies to satisfy different usage scenarios; for example, a heating spoon for scooping ice cream and a heating spoon for feeding children require different spoon bodies; in addition, heating of the spoon body of the heating spoon causes excess heat to be conducted to the handle, bringing an unfavorable user experience to the user.

### SUMMARY

Based on the aforementioned technical problems, this application provides a heating spoon including a handle and a spoon body; the handle includes a front end region, a middle portion, and a rear end region; the rear end region is a free end; the front end region, the middle portion, and the rear end region are sequentially arranged to cooperatively form the handle; the handle is a columnar structure; the columnar structure has a hollow region; a main circuit board is installed in the hollow region; the main circuit assembly is configured to provide power. The spoon body is made of a thermally conductive metal material and includes a connecting portion, a heating unit, and a heat-conducting portion. the connecting portion and the front end region are oppositely disposed; the connecting portion and the front end region are detachably connected; the heating unit is disposed on a side of the connecting portion away from the front end region; the heating unit and the main circuit assembly are electrically connected; the main circuit assembly is configured to supply power to the heating unit; the heating unit is configured to convert electrical energy into thermal energy; the connecting portion, the heating unit, and the heat-conducting portion are sequentially disposed; the heat-conducting portion is configured to receive the thermal energy generated by the heating unit.

Wherein, an embodiment provides a heating spoon including a handle and a spoon body; the handle includes a front end region, a middle portion, and a rear end region; the rear end region is a free end; the front end region, the middle portion, and the rear end region are sequentially arranged to cooperatively form the handle; the handle is a columnar structure; the columnar structure has a hollow region; a main circuit assembly is installed in the hollow region; the main circuit assembly is configured to provide power; the spoon body is made of a thermally conductive metal material; the spoon body has an accommodating space with an opening; the spoon body includes a heating unit, an inner surface, and an outer surface; the inner surface and the outer surface are oppositely disposed; the outer surface encloses an overall shape of the spoon body; the inner surface encloses the accommodating space; the position of the front end region corresponds to the position of the opening; the heating unit is accommodated in the accommodating space; when the opening and the front end region are matched and connected, the heating unit and the main circuit assembly are electrically connected; when the opening and the front end region are separated, the circuit between the heating unit and the main circuit assembly is disconnected.

Another embodiment provides a heating spoon including a handle and a spoon body. The handle is a housing having an inner peripheral wall and an outer peripheral wall; the housing is a columnar structure; the housing has a hollow region; the inner peripheral wall defines an overall contour of the hollow region; a main circuit assembly is installed in the hollow region; the main circuit assembly is configured to provide power. The spoon body is made of a thermally conductive metal material; the spoon body has an accommodating space with an opening; the spoon body includes a heating unit, an inner surface, and an outer surface; the inner surface and the outer surface are oppositely disposed; the outer surface encloses an overall shape of the spoon body; the inner surface encloses the accommodating space; the heating unit is accommodated in the accommodating space; when the handle and the spoon body are matched and connected, the heating unit and the main circuit assembly are electrically connected; when the handle and the spoon body are separated, the circuit between the heating unit and the main circuit assembly is disconnected.

### BRIEF DESCRIPTION OF THE DRAWINGS

The accompanying drawings described herein are provided to further understand this application and constitute a part of this application; the illustrative embodiments of this application and the descriptions thereof are used to explain this application and do not constitute an improper limitation of this application. Hereinafter, some specific embodiments of this application will be described in detail with reference to the accompanying drawings in an illustrative rather than limiting manner. The same reference numerals in the accompanying drawings denote the same or similar components or parts; those of ordinary skill in the art should understand that the drawings are not necessarily drawn to scale, wherein:

FIG. 1 is a schematic diagram of an overall structure of a heating spoon provided by this application;

FIG. 2 is a schematic diagram of the structure in FIG. 1 in which a spoon body and a handle are separated;

FIG. 3 is a schematic diagram of an exploded structure of the heating spoon provided by this application;

FIG. 4 is a cross-sectional diagram of the heating spoon provided in FIG. 1 taken along line A-A;

FIG. 5 is a schematic diagram of the overall structure of the handle as shown in FIG. 1;

FIG. 6 is a structural state diagram of the handle as shown in FIG. 5 from a first viewing angle;

FIG. 7 is an exploded structural diagram of the handle as shown in FIG. 5;

FIG. 8 is a schematic diagram of the overall structure of the spoon body as shown in FIG. 1;

FIG. 9 is a structural state diagram of the spoon body as shown in FIG. 8 from a first viewing angle;

FIG. 10 is an exploded structural diagram of the spoon body as shown in FIG. 8;

FIG. 11 is a structural schematic diagram of a gasket as shown in FIG. 10;

FIG. 12 is a structural schematic diagram of a protective sheet as shown in FIG. 10;

FIG. 13 is a schematic diagram of a circuit structure of the heating spoon of this application;

FIG. 14 is a structural schematic diagram of a first conductive terminal as shown in FIG. 7;

FIG. 15 is a structural schematic diagram of a second conductive terminal as shown in FIG. 10;

FIG. 16 is a structural schematic diagram of a heating sheet as shown in FIG. 10;

FIG. 17 is an exploded structural schematic diagram of the heating spoon provided by this application from another viewing angle;

FIG. 18 is a schematic diagram of the assembly structure of an outer sheath and a housing provided by this application;

FIG. 19 is a schematic diagram of the heating spoon provided by this application resting on a horizontal surface.

### DETAILED DESCRIPTION OF EMBODIMENTS

The technical solutions in the embodiments of this application will be clearly and completely described below in conjunction with the accompanying drawings in the embodiments of this application; of course, the described embodiments are only a part of the embodiments of this application, rather than all of the embodiments. Based on the embodiments of this application, all other embodiments obtained by a person of ordinary skill in the art without making creative efforts shall fall within the scope of protection of this application.

It should be noted that all directional indications (such as up, down, left, right, front, rear . . . ) in the embodiments of this application are only used to explain the relative positional relationships, movement conditions, etc. among the components under a certain specific posture (as shown in the drawings); if the specific posture changes, the directional indications shall change accordingly.

In addition, descriptions such as “first” and “second” in this application are only for descriptive purposes and shall not be construed as indicating or implying their relative importance or implicitly indicating the quantity of the indicated technical features. Thus, features defined as “first” and “second” may explicitly or implicitly include at least one such feature. In the description of this application, “plurality” means at least two, for example, two, three, etc., unless otherwise specifically defined.

In this application, unless otherwise expressly specified and limited, the terms “connected,” “fixed,” etc. shall be understood in a broad sense; for example, “fixed” can be a fixed connection, a detachable connection, or formed integrally; it can be a mechanical connection or an electrical connection; it can be a direct connection or an indirect connection through an intermediate medium; it can be internal communication between two elements or an interaction relationship between two elements, unless otherwise expressly limited. For a person of ordinary skill in the art, the specific meanings of the aforementioned terms in this application can be understood according to specific circumstances.

The drawings appearing in this application are only for illustrative explanation; the dimensions and shapes involved therein are only one form of embodiment and shall not be construed as limiting the scope of protection of the claims.

In addition, the technical solutions among the various embodiments of this application can be combined with each other, but such combination must be based on the ability of a person of ordinary skill in the art to implement; when the combination of technical solutions results in mutual contradiction or cannot be implemented, such combination shall be deemed not to exist and shall not fall within the scope of protection claimed in this application.

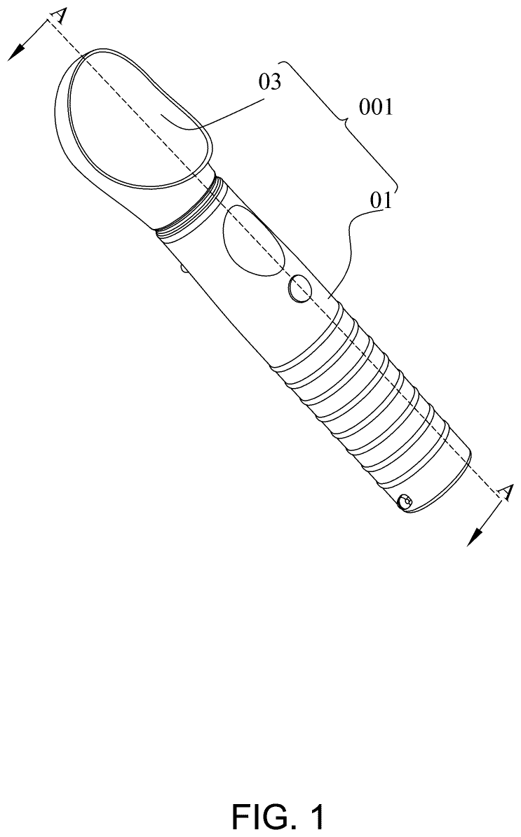

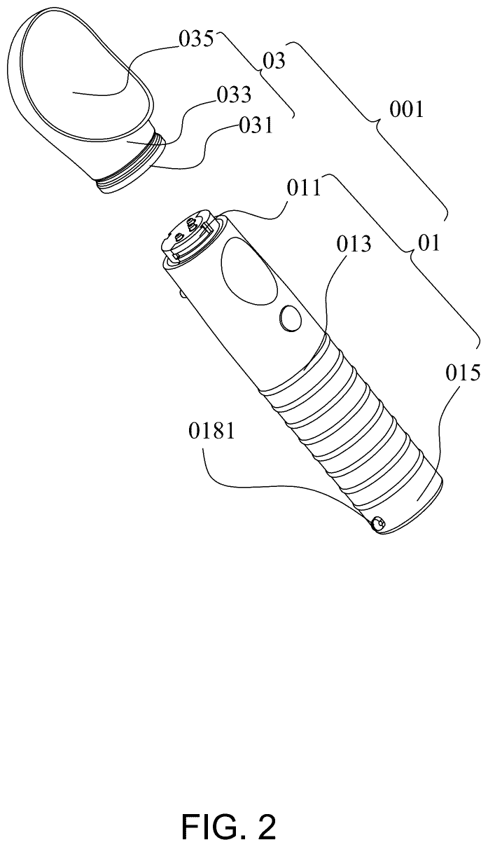

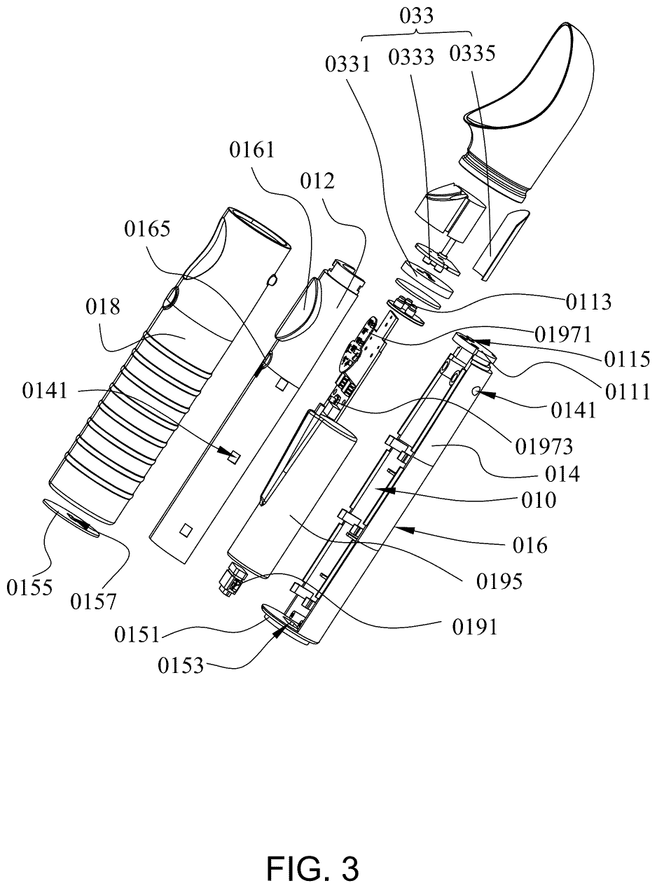

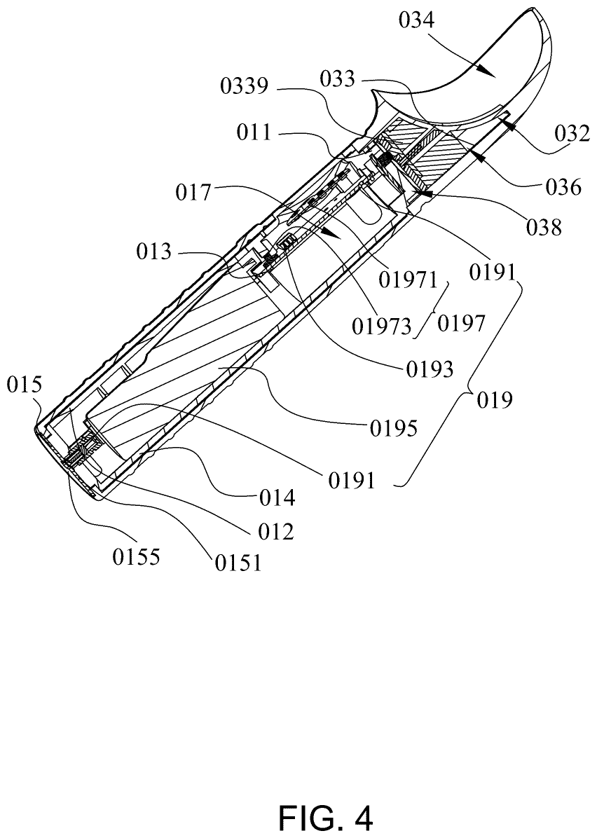

Please refer to FIG. 1 to FIG. 4. FIG. 1 is a schematic diagram of an overall structure of a heating spoon provided by this application; FIG. 2 is a schematic diagram of the structure in FIG. 1 in which a spoon body and a handle are separated; FIG. 3 is a schematic diagram of an exploded structure of the heating spoon provided by this application; FIG. 4 is a cross-sectional diagram of the heating spoon provided in FIG. 1 taken along line A-A. With particular reference to FIG. 1 and FIG. 2, a heating spoon 001 includes a handle 01 and a spoon body 03; the handle 01 and the spoon body 03 are detachably connected. The detachable connection means can be one of magnetic connection, adhesive connection, interference fit, snap-fit connection, slide groove fixed connection, buckle connection, bolt connection, or threaded connection. A snap-fit connection means is selected in the embodiments of this application.

The handle 01 includes a front end region 011, a middle portion 013, and a rear end region 015; the rear end region 015 is a free end; the front end region 011, the middle portion 013, and the rear end region 015 are sequentially arranged to cooperatively form the handle 01; the handle 01 is a columnar structure; the columnar structure has a hollow region 017. In this embodiment, the shape of the handle 01 is not particularly limited; for example, on the premise of satisfying the columnar structure, it can be a polygonal prism, a cylinder, an elliptical cylinder, or other irregular columnar structure, and as long as they can realize a columnar structure to be grasped by hand, all belong to the columnar structure mentioned in this application. The columnar structure having the hollow region 017 means that the overall appearance of the handle 01 is a columnar structure, and the columnar structure is hollow; that is, the handle 01 is a columnar shell structure having a certain thickness, and a hollow region 017 is hollowed out inside. The aforementioned columnar shell structure appears relatively smooth from the outside. In addition, it should be further noted that for ease of description in this application, the front end region 011, the middle portion 013, and the rear end region 015 are divided along the longitudinal direction of the columnar structure in spatial order; in an actual product, there is no obvious dividing boundary among the front end region 011, the middle portion 013, and the rear end region 015; of course, the front end region 011, the middle portion 013, and the rear end region 015 can be integrally formed, or can be fixedly connected along the longitudinal direction of the columnar structure; the fixed connection can be at least one of the fixed connection means of integral machining, welding, snap-fitting, interference fit, magnetic connection, screw or bolt connection, adhesive connection, or detachable connection. Integrally formed means integrally forming by injection molding, turn milling, cutting, or other processing methods; there is no connection or fitting relationship between the two, and there are no additional components for connection. Wherein, the front end region 011 is a region close to the spoon body 03, the middle portion 013 is disposed between the front end region 011 and the rear end region 015, and the rear end region 015 is a region away from the spoon body 03.

With particular reference to FIG. 3 and FIG. 4, a main circuit assembly 019 is installed in the hollow region 017; the main circuit assembly 019 is configured to provide power; the main circuit assembly 019 includes a charging port 0191, a processing unit 0193, a battery 0195, an operating unit 0197, a main circuit board 0191, and wires (not shown); the charging port 0191, the processing unit 0193, the battery 0195, the operating unit 0197, and the main circuit board 0191 are electrically connected. The charging port 0191 is configured for external connection with a power supply; the charging port 0191 is disposed at the rear end region 015; the rear end region 015 includes a rear end surface 0151; the rear end surface 0151 has an insertion slot 0153; the position of the insertion slot 0153 corresponds to the position of the charging port 0191; in actual use, a charging cable of the charging port 0191 can pass through the insertion slot 0153 and be inserted into the charging port 0191. In addition, in some embodiments, a protective cover 0155 can be further disposed; the protective cover 0155 is matched in shape to the rear end surface 0151 and then fits onto the rear end surface 0151 to protect the rear end surface 0151. Of course, a surface of the protective cover 0155 also has a through hole 0157, and the size and position of the through hole 0157 correspond to that of the insertion slot 0153.

Of course, in some embodiments of this application, the charging port 0191 can also be disposed at the middle portion 01 or the front end region 011.

The charging port 0191 introduces electrical energy to the heating spoon 001; the processing unit 0193 and the operating unit 0197 are both installed on the main circuit board 0191; the processing unit 0193 is configured to control heating parameters of the heating unit; the battery 0195 is configured for charging and discharging; during charging, it is configured to receive an external power supply; during discharging, the battery 0195 supplies power to the heating unit; the operating unit 0197 is at least one of a display screen, a buzzer, a button, and an indicator light. In this embodiment, the operating unit 0197 can simultaneously be disposed with a display screen 01971 and a button 01973. The heating parameters are at least one of temperature, time, and level. In the application, the aforementioned heating parameters can all be displayed on the display screen 01971, to allow an operator to perform a next operation according to the heating parameters displayed by the display screen 01971. For example, the display screen 01971 displays the current temperature as 15 degrees Celsius, and the operator's desired temperature is 90 degrees Celsius, then the operator can press the button 01973 to cause the heating spoon 001 to start heating.

The specific process of the aforementioned operation is that the charging port 0191 transfers electrical energy to the battery 0195 and the main circuit board 0191 through wires (not shown). After the battery 0195 is finished charging, after pressing the button 01973, the heating spoon 001 starts operating; the battery 0195 transmits electrical energy to the main circuit board 0191, and then supplies power to the processing unit 0193; the processing unit 0193 starts adjusting the corresponding heating parameters according to an instruction received from the button 01973 and controls the transmission of electrical energy to the spoon body 03 to heat the spoon body 03.

In this embodiment, the display screen 01971 can be a touch display screen, or can also be a button display screen. The processing unit 0193 can be at least one of a chip, a single-chip microcontroller, or a central processing unit (CPU). The battery 0195 is a rechargeable secondary battery, which can be a rechargeable secondary battery such as a lithium-ion battery, a lead-acid battery, a nickel-based battery, a solid-state battery, or a sodium-ion battery. In this application, a lithium-ion battery can be selected as an embodiment. The type of the charging port 0191 can be a USB series (for example: USB-A, USB-B, or USB-C), a Lightning series, or other charging port, which will not be described one by one herein. In addition, besides the aforementioned plug-in charging port, the charging port 0191 can also be a magnetic contact type, an electromagnetic inductive type, a clamping type, or other types.

The display screen 01971 can be an LED display screen, an LCD display screen, etc., which will not be listed one by one herein. When the display screen 01971 is a touch display screen, the button 01973 can be integrated into the display screen 01971, and the display screen 01971 is designed as a capacitive touch display screen, a resistive touch display screen, or an electromagnetic touch display screen; the operator can perform touch operations directly on the display screen 01971 to adjust the heating parameters of the heating spoon 001.

In addition, in one operation of the embodiment, the button 01973 is electrically signal-connected to the processing unit 0193 through the main circuit board 0191 and can separately implement at least one of “on/off,” “temperature,” “time,” “sleep,” “level,” or “child lock” information; at least a portion of the aforementioned information is displayed through the display screen 01971. Wherein, “on/off” controls the turning on and off of the heating spoon 001; “temperature increase” controls the heating or heat preservation function of the heating spoon 001; “time setting” controls the heating time of the heating spoon 001; “sleep” controls the heating spoon 001 to be in a standby state; “level selection” controls the heating speed of the heating spoon 001; and “child lock” controls that the heating spoon 001 can only start operating on the premise that the “child lock” switch is unlocked.

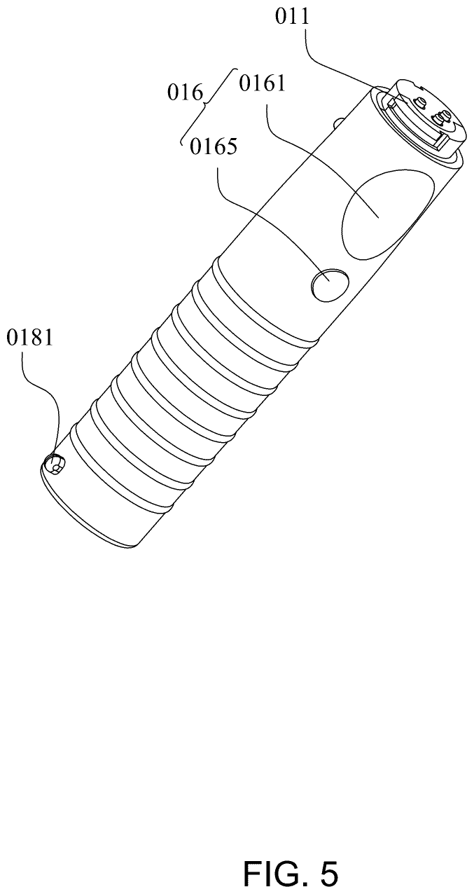

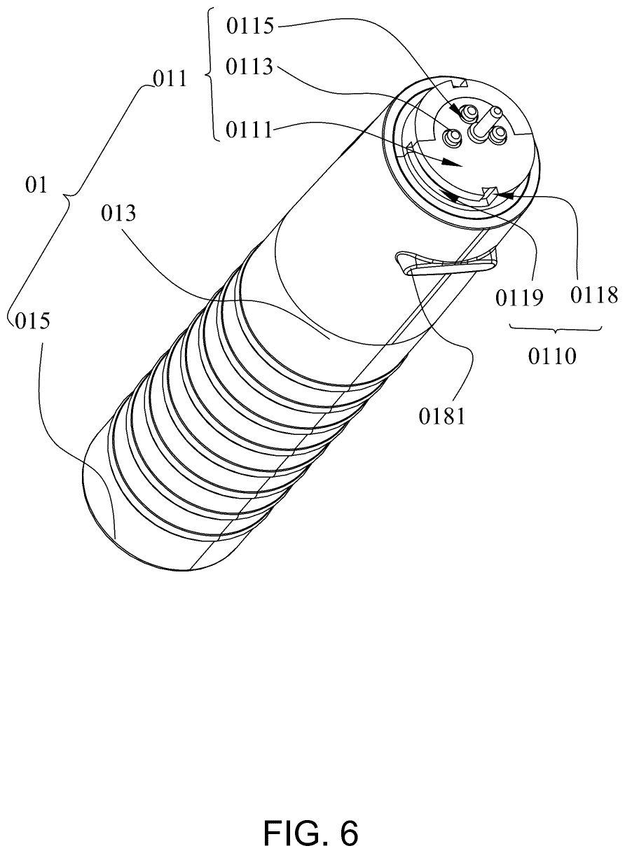

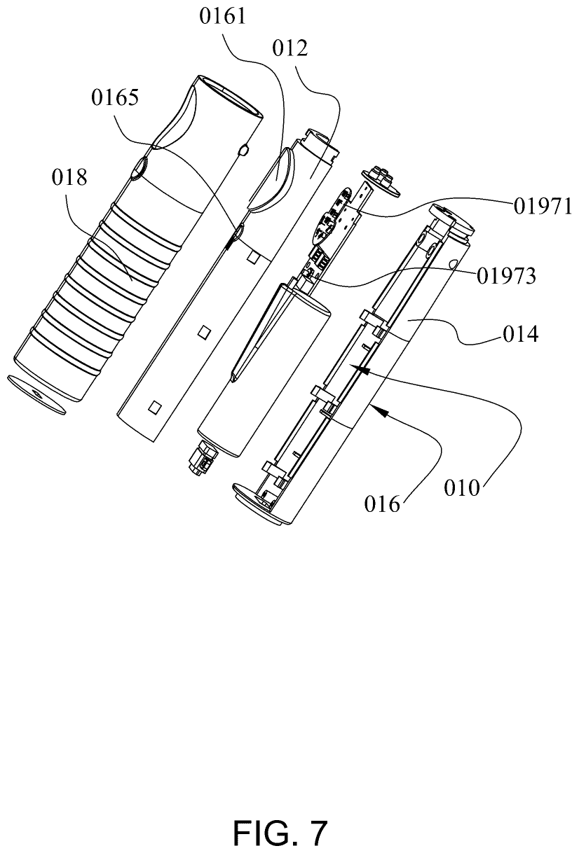

While simultaneously referring to FIG. 1 to FIG. 4 (particularly FIG. 3 and FIG. 4), please refer to FIG. 5 to FIG. 7. FIG. 5 is a schematic diagram of the overall structure of the handle as shown in FIG. 1; FIG. 6 is a structural state diagram of the handle as shown in FIG. 5 from a first viewing angle; FIG. 7 is an exploded structural diagram of the handle as shown in FIG. 5.

The handle 01 includes a first housing 012 and a second housing 014; the first housing 012 and the second housing 014 are detachably connected; the first housing 012 and the second housing 014 enclose the columnar structure; the main circuit assembly 019 is installed in the hollow region 017 enclosed by the first housing 012 and the second housing 014. Both the first housing 012 and the second housing 014 include an inner peripheral wall 010; the inner peripheral wall 010 defines the overall contour of the hollow region 017; both the first housing 012 and the second housing 014 include an outer peripheral wall 016; the outer peripheral wall 016 defines the overall contour of the columnar structure. An operation region 0161 is disposed on the surface of the outer peripheral wall 016; the position of the operation region 0161 corresponds to that of the operating unit 0197; the operation region 0161 can be protruding or recessed; for example, in one embodiment, the operation region 0161 protrudes relative to the outer peripheral wall 016 to reserve space for the operating unit 0197, so that the operation region 0161 can display on the display screen 01971 or perform pressing operations on the button 01973. Wherein, the region of the operation region 0161 corresponding to the display screen 01971 is designed as a light-transmitting or semi-light-transmitting material; for example, it is disposed as a layer of semi-transparent light-diffusing material, so that the operator can see the information displayed on the display screen 01971 through the operation region 0161. For example, the surface of the outer peripheral wall 016 is designed with an elastic button cover 0165; the elastic button cover 0165 corresponds to the position of the button 01973, so that the operator can press the button 01973 through the elastic button cover 0165.

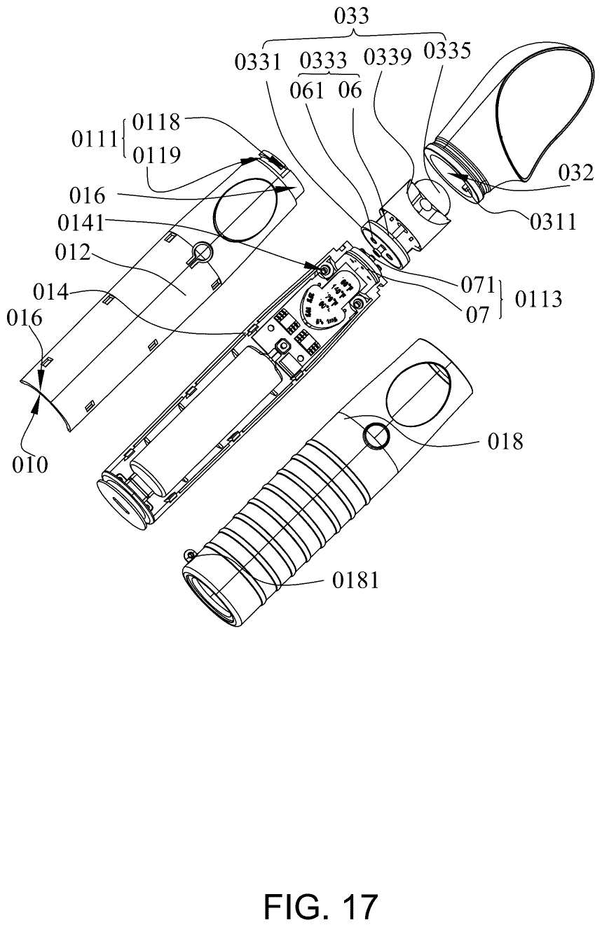

It should be noted that FIG. 3 and FIG. 17 can be referred to; FIG. 17 is an exploded structural schematic diagram of the heating spoon provided by this application from another viewing angle. The thicknesses of the first housing 012 and the second housing 014 are substantially the same; the two are oppositely disposed to realize detachable connection; the detachable connection means is at least one of screw connection or snap-fit connection. When the two are screw-connected, the first housing 012 and the second housing 014 can have screw holes 0141 at corresponding positions, and then the first housing 012 and the second housing 014 are connected by external screws (not shown); the quantity of screw holes 0141 is greater than or equal to 2; a person of ordinary skill in the art can set the quantity and positions of the screw holes 0141 according to actual conditions. In this application, the materials of the first housing 012 and the second housing 014 can be metal, plastic, silicone, glass, rubber, or other materials; in this embodiment, plastic material is selected.

In some embodiments, the handle 01 further includes an outer sheath 018; the outer sheath 018 is made of an elastic material; the outer sheath 018 is installed on the outer side of the outer peripheral wall 016. The material of the outer sheath 018 is not specifically limited; on the premise of satisfying elastic material, it can be silicone, rubber, plastic, or other elastic materials; it mainly serves to protect the first housing 012 and the second housing 014; after the first housing 012 and the second housing 014 are assembled, the outer sheath 018 is sleeved on the outer side of the first housing 012 and the second housing 014. In addition, a hanging ring 0181 can be provided in the outer sheath 018; the hanging ring 0181 facilitates storage of the heating spoon 001 and hangs the heating spoon 001 in a storage area. The size and shape of the hanging ring 0181 are not specifically limited herein. The material of the outer sheath 018 can be metal, plastic, silicone, glass, rubber, or other materials; in this embodiment, silicone material is selected. The thickness of the outer sheath 018 is slightly smaller than that of the handle 01, so that during assembly, the outer sheath 018 tightly wraps the handle 01.

In this application, the spoon body 03 and the handle 01 are made detachable, the first housing 012 and the second housing 014 are disposed as plastic material, and the outer sheath 018 is disposed as silicone material. Under the action of the three technical means, when the operator grasps the outer sheath 018 by hand, excessive heat emitted from the spoon body 03 will not be transferred to the palm.

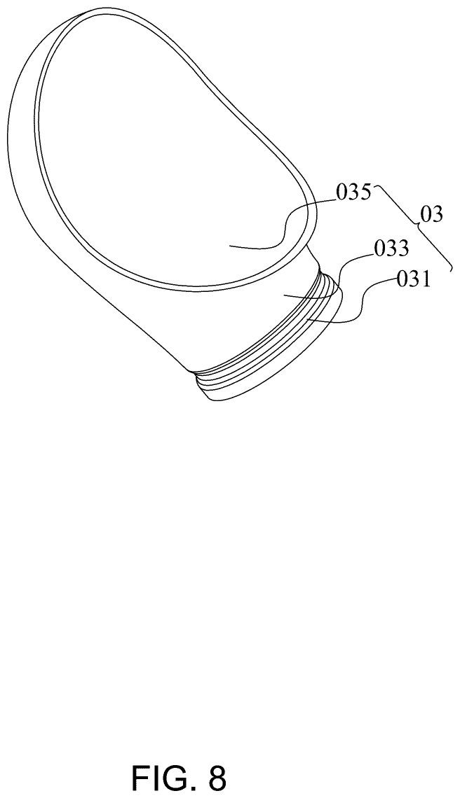

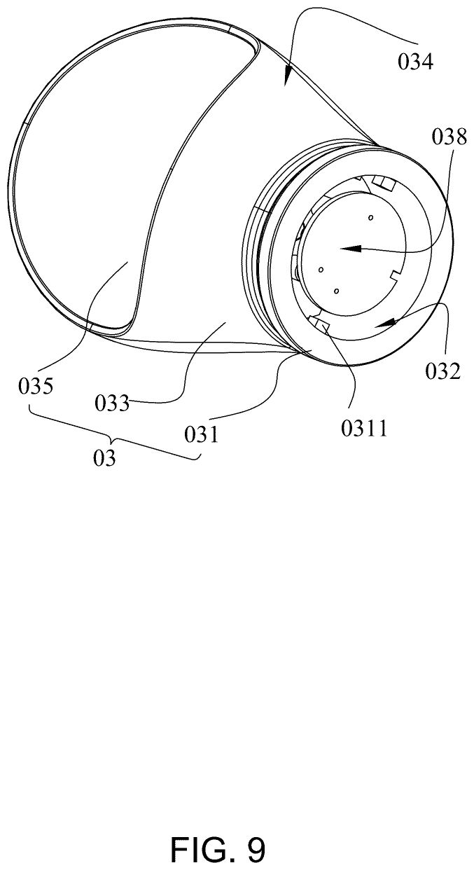

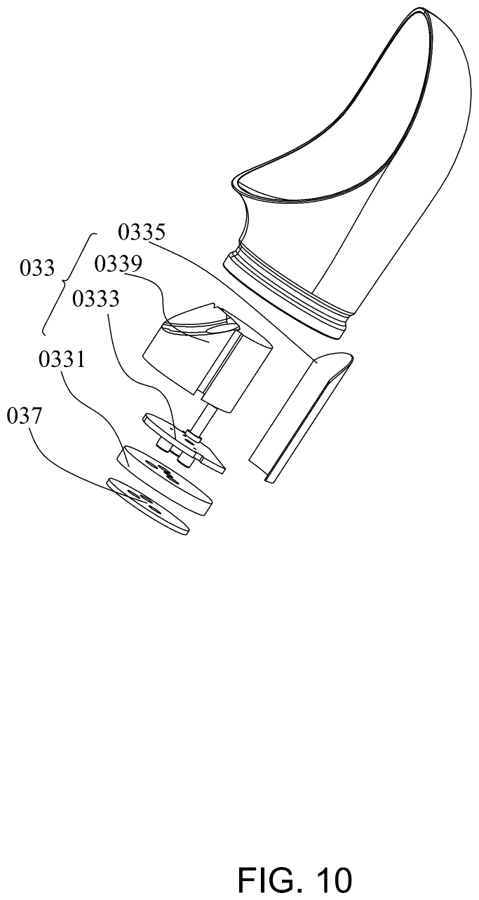

On the premise of referring to FIG. 1 to FIG. 4, please refer to FIG. 8 to FIG. 11. FIG. 8 is a schematic diagram of the overall structure of the spoon body as shown in FIG. 1; FIG. 9 is a structural state diagram of the spoon body as shown in FIG. 8 from a first viewing angle; FIG. 10 is an exploded structural diagram of the spoon body as shown in FIG. 8. The spoon body 03 is made of a thermally conductive metal material, such as stainless steel, aluminum alloy, titanium alloy, copper alloy, or other materials. The spoon body 03 includes a connecting portion 031, a heating unit 033, and a heat-conducting portion 035. Please particularly refer to FIG. 2; the connecting portion 031 and the front end region 011 are oppositely disposed; the connecting portion 031 and the front end region 011 are detachably connected, so that the spoon body 03 and the handle 01 are detachably connected. The heating unit 033 is disposed on a side of the connecting portion 031 away from the front end region 011; the heating unit 033 and the main circuit assembly 019 are electrically connected; the main circuit assembly 019 is configured to supply power to the heating unit 033; the heating unit 033 is configured to convert electrical energy into thermal energy; the connecting portion 031, the heating unit 033, and the heat-conducting portion 035 are sequentially disposed; the heat-conducting portion 035 is configured to receive the thermal energy generated by the heating unit 033. The shape of the heat-conducting portion 035 is designed to have a recessed region for containing food.

Please refer simultaneously to FIG. 1 and FIG. 2; when the connecting portion 031 is connected to the front end region 011, the heating unit 033 is electrically connected to the main circuit assembly 019. At this time, as shown in FIG. 1, the spoon body 03 and the handle 01 are connected. When the connecting portion 031 is separated from the front end region 011, the circuit between the heating unit 033 and the main circuit assembly 019 is disconnected. At this time, as shown in FIG. 2, the spoon body 03 and the handle 01 are separated.

In some embodiments of this application, the connection relationship between the spoon body 03 and the handle 01 can be as follows; wherein, relative rotation can occur between the spoon body 03 and the handle 01; when the spoon body 03 and the handle 01 rotate to a first position, the connecting portion 031 is connected to the front end region 011, and the heating unit 033 is electrically connected to the main circuit assembly 019; when the spoon body 03 and the handle 01 rotate to a second position, the connecting portion 031 is separated from the front end region 011, and the heating unit 033 and the main circuit assembly 019 are disconnected. For example, during actual use, when the spoon body 03 and the handle 01 rotate to the first position, the operator uses the heating spoon 001 to scoop ice cream or other food; after completion, the operator needs to clean the heating spoon 001; at this time, it is only necessary to rotate the spoon body 03 and the handle 01 to the second position; the operator can detach the spoon body 03 individually and clean the spoon body 03 individually, thereby preventing the main circuit assembly 019 in the handle 01 from being damaged by water ingress.

It should be noted that the specific shape of the spoon body 03 is not limited; on the premise that the connecting portion 031 is matched to the front end region 011, multiple spoon bodies 03 of different shapes can be designed for the same handle 01, thereby expanding the use scenarios of the heating spoon 001.

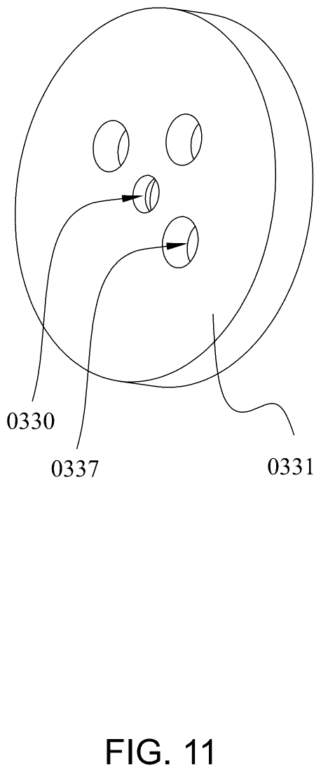

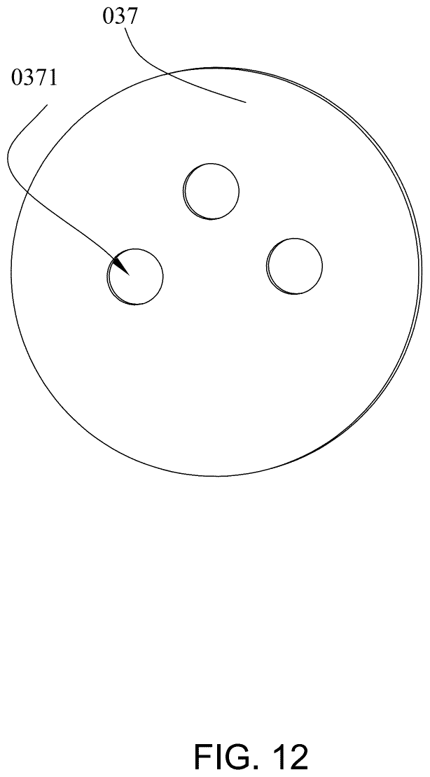

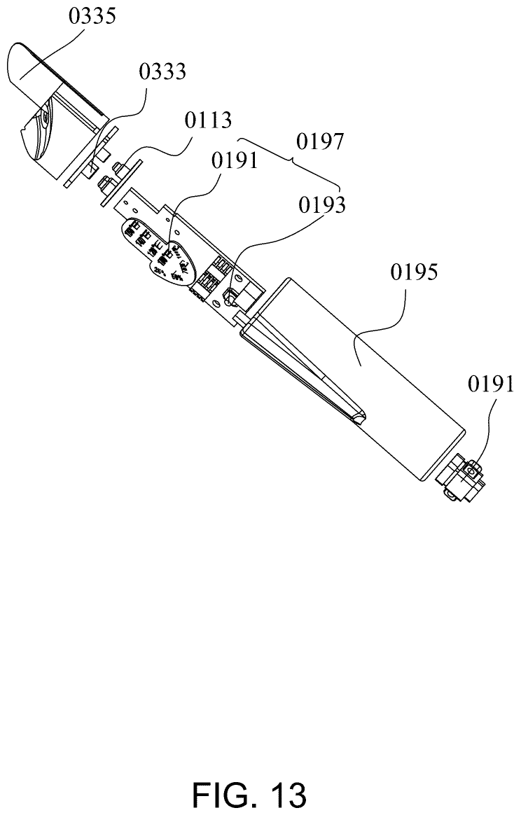

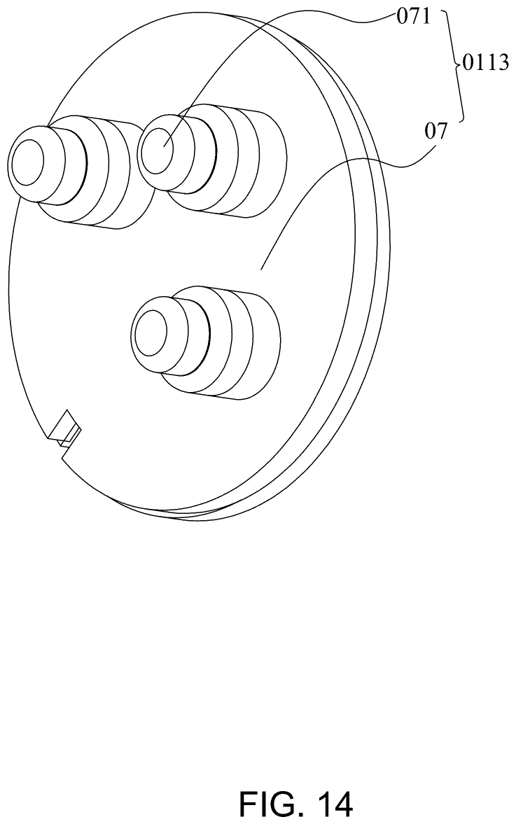

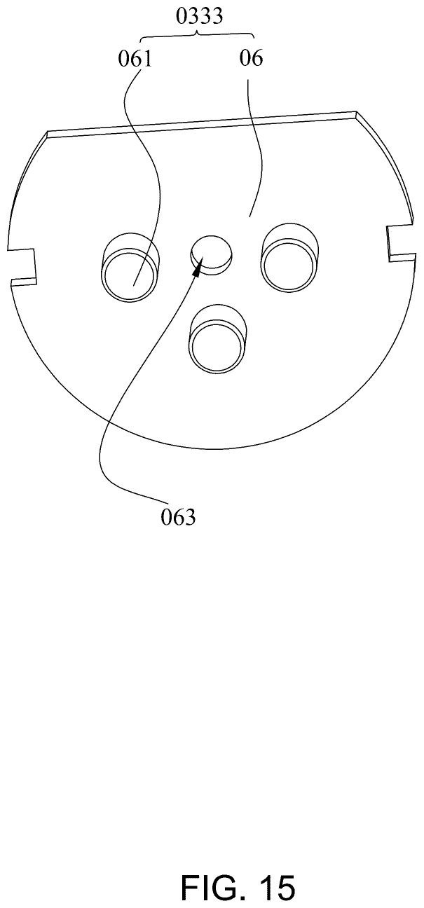

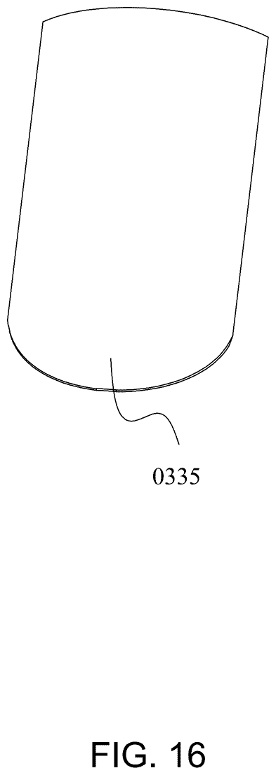

Please refer simultaneously to FIG. 11 to FIG. 17; FIG. 11 is a structural schematic diagram of a gasket as shown in FIG. 10; FIG. 12 is a structural schematic diagram of a protective sheet as shown in FIG. 10; FIG. 13 is a schematic diagram of a circuit structure of the heating spoon of this application; FIG. 14 is a structural schematic diagram of a first conductive terminal as shown in FIG. 7; FIG. 15 is a structural schematic diagram of a second conductive terminal as shown in FIG. 10; FIG. 16 is a structural schematic diagram of a heating sheet as shown in FIG. 10.

Referring simultaneously to FIG. 4 and FIG. 9, in this embodiment, the spoon body 03 includes an inner surface 032 and an outer surface 034; the inner surface 032 and the outer surface 034 are oppositely disposed; the outer surface 034 encloses the overall shape of the spoon body 03; the inner surface 032 encloses an accommodating space 036; the accommodating space 036 has an opening 038.

Please refer to FIG. 4, FIG. 6, and FIG. 9; when the spoon body 03 and the handle 01 are connected, the position of the front end region 011 corresponds to the position of the opening 038; specifically, the front end region 011 can be inserted into the opening 038. In addition, with respect to the spoon body 03, the position of the connecting portion 031 corresponds to the position of the opening 038; the heating unit 033 is accommodated in the accommodating space 036.

Please refer to FIG. 3, FIG. 4, FIG. 6, FIG. 9, FIG. 13, and FIG. 17; in some embodiments of this application, the internal circuit connection means of the heating spoon 001 is as follows: the front end region 011 includes a front end surface 0111 and a first conductive terminal 0113; wherein, at least a portion of the first conductive terminal 0113 is accommodated in the hollow region 017; the first conductive terminal 0113 is electrically connected to the main circuit assembly 019; the front end surface 0111 can be a portion of the first housing 012, or can also be a portion of the second housing 014; the front end surface 0111 can also exist independently relative to the first housing 012 or the second housing 014, and then there is an assembly connection relationship among the front end surface 0111, the first housing 012, and the second housing 014.

The front end surface 0111 has a first conductive hole 0115; the shape of the first conductive terminal 0113 is matched to the shape of the first conductive hole 0115; at least a portion of the first conductive terminal 0113 can pass through the first conductive hole 0115, so that the first conductive terminal 0113 extends out of the front end surface 0111. That is, one portion of the first conductive terminal 0113 is disposed on a side of the front end surface 0111 close to the hollow region 017, and another portion is disposed on a side of the front end surface 0111 away from the hollow region 017.

Please refer to FIG. 14 and FIG. 17; in the embodiments of this application, the first conductive terminal 0113 includes a first circuit board 07 and a first conductive contact 071; the first circuit board 07 and the first conductive contact 071 are electrically connected; the first circuit board 07 is electrically connected to the main circuit assembly 019, thereby enabling electrical connection between the main circuit assembly 019 and the first conductive contact 071. In this embodiment, the first conductive contact 071 of the first conductive terminal 0113 passes through the first conductive hole 0115, thereby extending out of the front end surface 0111; and the first circuit board 07 is disposed in the hollow region 017.

Please refer to FIG. 3, FIG. 4, FIG. 9, FIG. 10, FIG. 11, FIG. 13, and FIG. 17; the heating unit 033 includes a gasket 0331, a second conductive terminal 0333, and a heating sheet 0335. The gasket 0331, the second conductive terminal 0333, and the heating sheet 0335 can all be accommodated in the accommodating space 036; wherein, the gasket 0331 has a second conductive hole 0337; the shape of the second conductive terminal 0333 is matched to the shape of the second conductive hole 0337; the second conductive terminal 0333 corresponds in position to that of the second conductive hole 0337; the second conductive terminal 0333 passes through the second conductive hole 0337. That is, one portion of the second conductive terminal 0333 is disposed on a side of the gasket 0331 close to the accommodating space 036, and another portion is disposed on a side of the gasket 0331 away from the accommodating space 036.

Please refer simultaneously to FIG. 15; the second conductive terminal 0333 includes a second circuit board 06 and a second conductive contact 061; the second circuit board 06 and the second conductive contact 061 are electrically connected. The second conductive contact 061 of the second conductive terminal 0333 passes through the second conductive hole 0337, thereby being disposed on a side of the gasket 0331 away from the accommodating space 036, and can be electrically connected to the first conductive contact 071 of the first conductive terminal 0113. The second circuit board 06 of the second conductive terminal 0333 is disposed on a side of the gasket 0331 close to the accommodating space 036.

The heating unit 033 further includes the heating sheet 0335, configured to transfer heat to the heat-conducting portion 035; at least a portion of the heating sheet 0335 is in contact with the inner surface 032. The main circuit assembly 019, the first conductive terminal 0113, the second conductive terminal 0333, and the heating sheet 0335 are electrically connected. The gasket 0331 and the second conductive terminal 0333 are detachably connected.

Relative movement can occur between the spoon body 03 and the handle 01; for example, rotation can occur between the two. In this embodiment, when the spoon body 03 and the handle 01 rotate to the first position, the connecting portion 031 is connected to the front end region 011; at least a portion of the second conductive terminal 0333 passes through the second conductive hole 0337; at least a portion of the first conductive terminal 0113 passes through the first conductive hole 0115; at this time, the second conductive hole 0337 and the first conductive hole 0115 are disposed correspondingly in position, so that the first conductive terminal 0113 and the second conductive terminal 0333 abut against each other and are electrically connected, enabling electrical connection among the main circuit assembly 019, the first conductive terminal 0113, the second conductive terminal 0333, and the heating sheet 0335; when the circuit is connected, the heating sheet 0335 begins to emit heat, and the heating spoon 001 begins to be in a heating working state. When the spoon body 03 and the handle 01 rotate to the second position, the connecting portion 031 is separated from the front end region 011; at this time, the positions of the second conductive hole 0337 and the first conductive hole 0115 no longer correspond, and deviation occurs between the two, so that the first conductive terminal 0113 and the second conductive terminal 0333 no longer abut or contact each other, thereby disconnecting the circuit among the main circuit assembly 019, the first conductive terminal 0113, the second conductive terminal 0333, and the heating sheet 0335; the heating sheet 0335 no longer generates heat, and the heating spoon 001 is in an off state.

It should be noted that, in some embodiments, at least one of the first conductive terminal 0113 and the second conductive terminal 0333 is an elastic electronic component, and the elastic electronic component can expand and contract under the action of an external force. When the spoon body 03 and the handle 01 rotate to the first position and the first conductive terminal 0113 and the second conductive terminal 0333 are in an electrically connected state, at least one of the two contracts under the action of external force, causing the first conductive terminal 0113 and the second conductive terminal 0333 to abut against each other, so that the electrical signal between the two is stable. When the spoon body 03 and the handle 01 rotate to the second position and the first conductive terminal 0113 and the second conductive terminal 0333 are misaligned and in a disconnected circuit state, the first conductive terminal 0113 and the second conductive terminal 0333 no longer abut against each other. As shown in FIG. 17, furthermore, at least one of the first conductive contact 071 and the second conductive contact 061 is an elastic electronic component, and the elastic electronic component can expand and contract under the action of external force. When the spoon body 03 and the handle 01 rotate to the first position and the first conductive contact 071 and the second conductive contact 061 are in an electrically connected state, at least one of the two contracts under the action of external force, causing the first conductive contact 071 and the second conductive contact 061 to abut against each other, so that the electrical signal between the two is stable. When the spoon body 03 and the handle 01 rotate to the second position and the first conductive contact 071 and the second conductive contact 061 are misaligned and in a disconnected circuit state, the first conductive contact 071 and the second conductive contact 061 no longer abut against each other.

In some embodiments of this application, the spoon body 03 further includes a protective sheet 037; the protective sheet 037 is a thin plate-like structure, and an alignment hole 0371 is on a surface thereof; the position of the alignment hole 0371 corresponds to the position of the second conductive hole 0337, and the two are coaxially disposed; at least a portion of the second conductive terminal 0333 can pass through the alignment hole 0371; the alignment hole 0371 and the second conductive hole 0337 can simultaneously rotate relative to the first conductive hole 0115. The protective sheet 037 and the gasket 0331 are detachably connected.

In addition, in some embodiments of this application, the protective sheet 037 and the gasket 0331 are both disposed at the opening 038; wherein, the protective sheet 037 is disposed at the gasket 0331 and the front end surface 0111; the surface of the protective sheet 037 is relatively smooth; when the first conductive terminal 0113 and the second conductive terminal 0333 rotate relative to each other, the gasket 0331 and the protective sheet 037 rotate simultaneously relative to the front end surface 0111, thereby causing relative rotation between the spoon body 03 and the handle 01. Because the surface of the protective sheet 037 is relatively smooth, the relative rotation between the first conductive terminal 0113 and the second conductive terminal 0333 is smoother.

In other embodiments of this application, the connection and disconnection between the first conductive terminal 0113 and the second conductive terminal 0333 can be realized not only by rotating the spoon body 03 and the handle 01, but also by plugging and unplugging the spoon body 03 and the handle 01; for example, magnetic members can be disposed between the spoon body 03 and the handle 01; when the two are fit together, the first conductive terminal 0113 and the second conductive terminal 0333 are electrically connected; when the two are separated, the circuit between the first conductive terminal 0113 and the second conductive terminal 0333 is disconnected.

Please refer to FIG. 4, FIG. 10, and FIG. 17. In other embodiments, the heating unit 033 can further be disposed with a filler 0339; the filler 0339 is filled in the accommodating space 036. In this embodiment, the filler 0339 can be a relatively thick coating configured to fill the accommodating space 036, and the filler 0339 covers at least a portion of the heating unit 0335. It should be noted that at least a portion of the heating unit 0335 described in this embodiment can be at least one of a heating sheet, a heating wire, or a graphene heating material. The filler 0339 can be epoxy resin material, polymer material, polyurethane material, silicone material, rubber material, elastomer material, or the like. The filler 0339 can fill gaps in the accommodating space 036; on the one hand, it provides waterproofing; under encapsulation of the filler 0339, the gasket 0331, the second conductive terminal 0333, and the heating sheet 0335 are sealed within the accommodating space 036; of course, the second conductive terminal 0333 will remain exposed. During cleaning of the spoon body 03, damage to the heating sheet 0335 by water stains is prevented as much as possible. On the other hand, the filler 0339 can provide heat dissipation; the filler 0339 diffuses heat generated by the heating sheet 0335, allowing the heat emitted by the heating sheet 0335 to be more uniformly distributed and ultimately transferred to the heat-conducting portion 035.

Please refer to FIG. 11, FIG. 15, and FIG. 17. During actual assembly, in some embodiments, a screw 08 can further be disposed; wherein, the gasket 0331 has an outer installation hole 0330, and the second conductive terminal 0333 has an inner installation hole 063; the outer installation hole 0330 corresponds in position to the inner installation hole 063; the screw 08 is sequentially inserted into the outer installation hole 0330 and the inner installation hole 063, thereby aligning the gasket 0331 and the second conductive terminal 0333 to prevent displacement between the two.

Please refer to FIG. 4, FIG. 6, FIG. 8, and FIG. 9. In this embodiment, the spoon body 03 includes an inner surface 032 and an outer surface 034; the inner surface 032 and the outer surface 034 are oppositely disposed; the outer surface 034 encloses the overall shape of the spoon body 03; the inner surface 032 encloses the accommodating space 036; the accommodating space 036 has an opening 038; the connecting portion 031 is disposed at the opening 038; during assembly, the position of the front end region 011 corresponds to the position of the opening 038; the connecting portion 031 and the front end region 011 realize connection; the heating unit 033 is accommodated in the accommodating space 036. At the opening 038, the inner surface 032 defines the overall shape of the opening 038; in this application, the overall shape of the opening 038 is not specifically limited and can be circular, square, elliptical, or other irregular shapes; in this embodiment, a circular shape is selected as an example, and in this case, the opening 038 forms a circular hole. At the front end region 011, the first housing 012 and/or the second housing 014 forms a columnar structure; the columnar structure can be a prism, a cylinder, an elliptical cylinder, or other columnar shapes; in this embodiment, the columnar structure is designed as a cylinder; the size of the cylinder matches the size of the circular hole, and the cylinder can be inserted into the circular hole.

The connecting portion 031 of the spoon body 03 further includes a first connecting unit 0311; the first connecting unit 0311 is disposed at the opening 038; the front end region 011 of the handle 01 further includes a second connecting unit 0110; the second connecting unit 0110 is disposed on the inner peripheral wall 010 or the outer peripheral wall 016; the first connecting unit 0311 and the second connecting unit 0110 are matched to each other and are configured for detachable connection between the first connecting unit 0311 and the second connecting unit 0110.

The first connecting unit 0311 and the second connecting unit 0110 are mutually matching connecting components; for example, the first connecting unit 0311 and the second connecting unit 0110 can be matching threads, or can also be a matching groove space and protrusion, or can also be a pair of magnetic members attracting each other, or can also be a matching hole and screw. In addition, in this embodiment, the position of the front end region 011 corresponds to the position of the opening 038, and the heating unit 033 is accommodated in the accommodating space 036; when the opening 038 and the front end region 011 are matched and connected, the heating unit 033 and the main circuit assembly 019 are electrically connected; when the opening 038 and the front end region 011 are separated, the circuit between the heating unit 033 and the main circuit assembly 019 is disconnected.

Please refer to FIG. 6, FIG. 9, and FIG. 17. The first connecting unit 0311 is a protrusion 0311, which is disposed on the inner surface 032 at the opening 038; that is, it is disposed on the inner surface 032 of the circular hole; the protrusion 0311 protrudes from the inner surface 032 of the circular hole. The second connecting unit 0110 is a groove-shaped space 0111; the groove-shaped space 0110 is disposed on the side wall (outer peripheral wall 016) of the cylinder; the groove-shaped space 0111 includes an entry groove 0118 and a locking groove 0119. Wherein, the size of the entry groove 0118, the size of the locking groove 0119, and the size of the protrusion 0311 are matched; the protrusion 0311 can slide freely within the entry groove 0118 and the locking groove 0119. The entry groove 0118 and the locking groove 0119 communicate with each other, and an included angle exists between the two; the included angle can be set at 90 degrees. It should be noted that in some embodiments, the quantities of the groove-shaped space 0111 and protrusion 0311 can be greater than or equal to two.

Meanwhile, the front end surface 0111 can be accommodated within the connecting portion 031, thereby realizing matching between the front end region 011 and the connecting portion 031. In this embodiment, the shape of the front end surface 0111 is substantially circular, such that the front end region 011 is substantially cylindrical; meanwhile, the shape of the opening 038 at the connecting portion 031 is circular, such that the inner surface 032 at the opening 038 is substantially a circular hole. At this time, the front end region 011 can extend into the opening 038, allowing the outer peripheral wall 016 to contact the inner surface 032. At this time, the entry groove 0118 and the locking groove 0119 are on the outer peripheral wall 016 of the front end region 011.

In this embodiment, relative rotation can occur between the spoon body 03 and the handle 01; the process of rotating the spoon body 03 and the handle 01 to the first position is as follows: the protrusion 0311 is aligned with the locking groove 0119 and can enter the locking groove 0119, allowing the front end region 011 to extend into the opening 038, thereby connecting the connecting portion 031 and the front end region 011. Subsequently, the handle 01 or the spoon body 03 is rotated, and the protrusion 0311 moves along the locking groove 0119; at this time, at least a portion of the second conductive terminal 0333 passes through the second conductive hole 0337, and at least a portion of the first conductive terminal 0113 can pass through the first conductive hole 0115; at the same time, the positions of the second conductive hole 0337 and the first conductive hole 0115 also rotate relative to each other; as the protrusion 0311 moves along the locking groove 0119, the positions of the second conductive hole 0337 and the first conductive hole 0115 are aligned, the first conductive terminal 0113 corresponds to the second conductive terminal 0333, and the first conductive terminal 0113 and the second conductive terminal 0333 abut each other to realize electrical connection, thereby electrically connecting the main circuit assembly 019, the first conductive terminal 0113, the second conductive terminal 0333, and the heating sheet 0335; when the circuit is connected, the heating sheet 0335 begins to emit heat, and the heating spoon 001 begins to be in a heating working state.

When the spoon body 03 needs to be cleaned, the process of rotating the spoon body 03 and the handle 01 to the second position is as follows (which is actually the aforementioned process performed in reverse):

Initially, the protrusion 0311 is located in the locking groove 0119, and the first conductive terminal 0113 and the second conductive terminal 0333 abut against each other and realize electrical connection; the spoon body 03 or the handle 01 is rotated, and the protrusion 0311 moves within the locking groove 0119; as the protrusion 0311 moves in the locking groove 0119, the positions of the second conductive hole 0337 and the first conductive hole 0115 are no longer aligned, causing deviation between the two, causing the circuit to disconnect between the first conductive terminal 0113 and the second conductive terminal 0333, and among the main circuit assembly 019, the first conductive terminal 0113, the second conductive terminal 0333, and the heating sheet 0335; when the protrusion 0311 moves to the entry groove 0118, the protrusion 0311 moves along the entry groove 0118 to exit out, causing the front end region 011 to exit out of the opening 038, and the spoon body 03 and the handle 01 can be separated, and the heating spoon 001 begins to be in a non-working state.

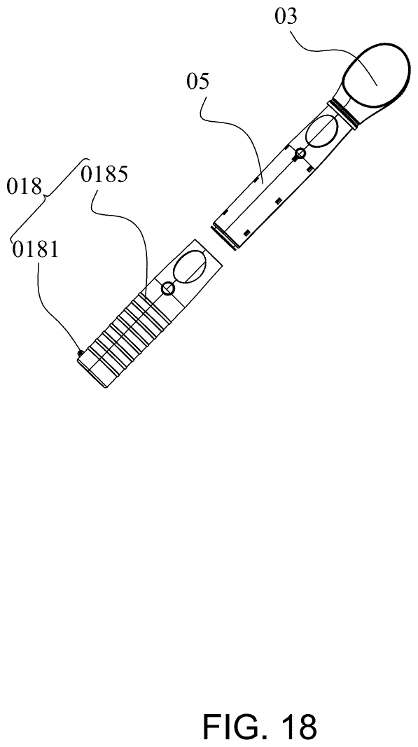

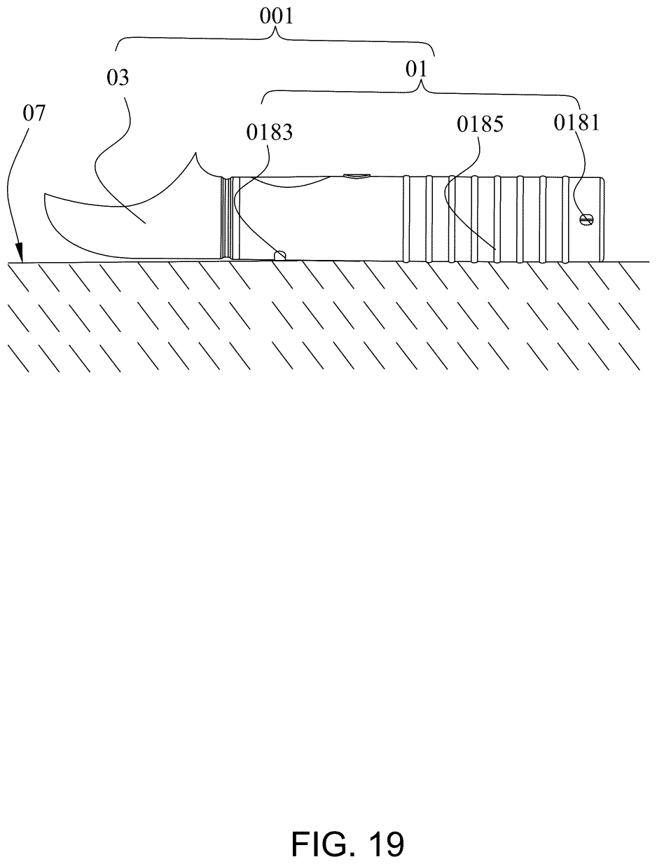

Please refer to FIG. 6, FIG. 7, FIG. 18, and FIG. 19. FIG. 18 is a schematic diagram of the assembly structure of the outer sheath and a housing provided by this application; FIG. 19 is a schematic diagram of the heating spoon provided by this application resting on a horizontal surface. In some embodiments of this application, the handle 01 can be a housing 05 having the inner peripheral wall 010 or the outer peripheral wall 016, and the housing 05 is an integrally formed structure. In some embodiments, a surface of the outer sheath 018 away from the housing 05 is designed with a support post 0183 configured such that when the heating spoon 001 is placed on a horizontal surface, the support post 0183 and the handle 01 contact a horizontal surface 07, and the spoon body 03 is away from the horizontal surface 07 to prevent the spoon body 03 from staining; it should be noted that the horizontal surface 07 can be a tabletop, flat ground, or similar scenarios, and any scenario forming a horizontal surface falls within the application scenarios of this embodiment. A surface of the outer sheath 018 away from the housing 05 is designed with a plurality of protruding edges 0185, which are configured to increase friction when an operator grasps the handle 01 by hand.

The electrical connection mentioned in this application can be a physical connection by means of wires, or can be a wireless electrical signal connection; the electrical signal herein can be at least one of a current signal, a voltage signal, a resistance signal, a Bluetooth signal, or a Wi-Fi signal.

The descriptive terms “substantially,” “approximately,” and “close to” mentioned in this application mean that, relative to a standard value, the fluctuation range can vary within ±20%.

The term “at least one” mentioned in this application means that it can be one situation among them, or can be a coexistence of multiple situations. For example, “at least one of A, B, and C” includes all combinations such as A alone, B alone, C alone, A and B coexisting, A and C coexisting, and other arrangement combinations. Details are not explained one by one. The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A or B”, unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

The foregoing describes only embodiment of this application; it should be noted here that those of ordinary skill in the art can make improvements without departing from the inventive concept of this application, and such improvements shall fall within the protection scope of this application.

What is claimed is:

1. A heating spoon, characterized by comprising:
a handle comprising:
a front end region;
a middle portion;
a rear end region; the rear end region is a free end; the front end region, the middle portion, and the rear end region are sequentially arranged to cooperatively form the handle;
the handle is a columnar structure; the columnar structure has a hollow region;
a main circuit assembly installed in the hollow region; the main circuit assembly is configured to provide power;
a spoon body made of a thermally conductive metal material and comprising:
a connecting portion; the connecting portion and the front end region are oppositely disposed; the connecting portion and the front end region are detachably connected;
a heating unit disposed on a side of the connecting portion away from the front end region; the heating unit and the main circuit assembly are electrically connected; the main circuit assembly is configured to supply power to the heating unit; the heating unit is configured to convert electrical energy into thermal energy;
a heat-conducting portion; the connecting portion, the heating unit, and the heat-conducting portion are sequentially disposed; the heat-conducting portion is configured to receive the thermal energy generated by the heating unit.

2. The heating spoon according to claim 1, characterized in that, when the connecting portion is connected to the front end region, the heating unit is electrically connected to the main circuit assembly;
when the connecting portion is separated from the front end region, the circuit between the heating unit and the main circuit assembly is disconnected.

3. The heating spoon according to claim 1, characterized in that, relative rotation occurs between the spoon body and the handle;
when the spoon body and the handle rotate to a first position, the connecting portion is connected to the front end region, and the heating unit is electrically connected to the main circuit assembly;
when the spoon body and the handle rotate to a second position, the connecting portion is separated from the front end region, and the heating unit and the main circuit assembly are disconnected.

4. The heating spoon according to claim 1, characterized in that, the spoon body comprises:
an inner surface;
an outer surface; the inner surface and the outer surface are oppositely disposed; the outer surface encloses the overall shape of the spoon body; the inner surface encloses an accommodating space; the accommodating space has an opening;
the position of the front end region corresponds to the position of the opening; the connecting portion is disposed at the opening; the heating unit is accommodated in the accommodating space.

5. The heating spoon according to claim 1, characterized in that, the handle comprises:
a first housing;
a second housing; the first housing and the second housing are detachably connected; the first housing and the second housing enclose the columnar structure; the main circuit assembly is installed between the first housing and the second housing.

6. The heating spoon according to claim 5, characterized in that, both the first housing and the second housing comprise an inner peripheral wall; the inner peripheral wall defines the overall contour of the hollow region; both the first housing and the second housing comprise an outer peripheral wall; the outer peripheral wall defines the overall contour of the columnar structure.

7. The heating spoon according to claim 6, characterized in that, the handle further comprises an outer sheath; the outer sheath is made of an elastic material; the outer sheath is encased on the outer side of the outer peripheral wall.

8. The heating spoon according to claim 1, characterized in that, the main circuit assembly comprises:
a charging port configured for external connection with a power supply;
a processing unit configured to control heating parameters of the heating unit;
a battery configured for charging and discharging; during charging, the battery is configured to receive the power supply; during discharging, the battery supplies power to the heating unit;
an operating unit;
a main circuit board; the processing unit and the operating unit are both installed on the main circuit board; the heating unit, the charging port, the processing unit, the battery, and the operating unit are electrically connected.

9. The heating spoon according to claim 8, characterized in that, the operating unit is at least one of a display screen, a button, and an indicator light.

10. The heating spoon according to claim 8, characterized in that, the heating parameters are at least one of temperature, time, and level.

11. The heating spoon according to claim 1, characterized in that, the front end region comprises:
a front end surface; the front end surface can be accommodated in the connecting portion; the front end surface has a first conductive hole;
a first conductive terminal; the first conductive terminal is disposed on a side of the front end surface away from the connecting portion; the heating unit, the first conductive terminal, and the main circuit assembly are electrically connected; the main circuit assembly provides power to the heating unit through the first conductive terminal;
the position of the first conductive terminal corresponds to that of the first conductive hole; the first conductive terminal passes through the first conductive hole.

12. The heating spoon according to claim 11, characterized in that, the heating unit comprises:
a gasket; the gasket has a second conductive hole;
a second conductive terminal; the gasket and the first conductive terminal are detachably connected; the heating unit, the second conductive terminal, and the first conductive terminal are electrically connected;
the position of the second conductive terminal corresponds to that of the second conductive hole; the second conductive terminal passes through the second conductive hole.

13. The heating spoon according to claim 12, characterized in that, when the position of the first conductive hole corresponds to the position of the second conductive hole, the first conductive terminal and the second conductive terminal contact each other to enable electrical connection between the first conductive terminal and the second conductive terminal.

14. The heating spoon according to claim 4, characterized in that, the heating unit comprises:
a heating sheet; the heating sheet is disposed in the accommodating space; the heating sheet is electrically connected to the main circuit assembly; the heating sheet is configured to transfer heat to the heat-conducting portion; at least a portion of the heating sheet contacts the inner surface.

15. The heating spoon according to claim 4, characterized in that, the heating unit further comprises a filler; the filler is filled in the accommodating space.

16. The heating spoon according to claim 6, characterized in that, the spoon body comprises:
an inner surface;
an outer surface; the inner surface and the outer surface are oppositely disposed; the outer surface encloses the overall shape of the spoon body; the inner surface encloses an accommodating space; the accommodating space has an opening;
the position of the front end corresponds to the position of the opening; the connecting portion is disposed at the opening; the heating unit is accommodated in the accommodating space; at the opening, the inner surface defines the overall shape of the opening;
the connecting portion further comprises a first connecting unit; the first connecting unit is disposed at the opening;
the front end region further comprises a second connecting unit; the second connecting unit is disposed on the inner peripheral wall or the outer peripheral wall;
the first connecting unit and the second connecting unit match each other to configure detachable connection between the first connecting unit and the second connecting unit.

17. A heating spoon, characterized by comprising:
a handle comprising:
a front end region;
a middle portion;
a rear end region; the rear end region is a free end; the front end region, the middle portion, and the rear end region are sequentially arranged to cooperatively form the handle; the handle is a columnar structure; the columnar structure has a hollow region;
a main circuit assembly installed in the hollow region; the main circuit assembly is configured to provide power;
a spoon body made of a thermally conductive metal material; the spoon body has an accommodating space with an opening; the spoon body comprises:
a heating unit;
an inner surface;
an outer surface; the inner surface and the outer surface are oppositely disposed; the outer surface encloses an overall shape of the spoon body; the inner surface encloses the accommodating space;
the position of the front end region corresponds to the position of the opening; the heating unit is accommodated in the accommodating space;
when the opening and the front end region are matched and connected, the heating unit and the main circuit assembly are electrically connected;
when the opening and the front end region are separated, the circuit between the heating unit and the main circuit assembly is disconnected.

18. The heating spoon according to claim 17, characterized in that, the inner surface is disposed with a layer formed by a filler to configure the layer to fill in the accommodating space; the layer covers at least a portion of the heating unit.

19. A heating spoon, characterized by comprising:
a handle; the handle is a housing having an inner peripheral wall and an outer peripheral wall; the housing is a columnar structure; the housing has a hollow region; the inner peripheral wall defines an overall contour of the hollow region;
a main circuit assembly installed in the hollow region; the main circuit assembly is configured to provide power;
a spoon body made of a thermally conductive metal material; the spoon body has an accommodating space with an opening; the spoon body comprises:
a heating unit;
an inner surface;
an outer surface; the inner surface and the outer surface are oppositely disposed; the outer surface encloses an overall shape of the spoon body; the inner surface encloses the accommodating space; the heating unit is accommodated in the accommodating space;
when the handle and the spoon body are matched and connected, the heating unit and the main circuit assembly are electrically connected;
when the handle and the spoon body are separated, the circuit between the heating unit and the main circuit assembly is disconnected.

20. The heating spoon according to claim 19, characterized in that, the handle further comprises an outer sheath; the outer sheath is made of an elastic material; the outer sheath is encased on the outer side of the outer peripheral wall.

21. The heating spoon according to claim 20, characterized in that, a surface of the outer sheath away from the housing is designed with a plurality of protruding edges configured to increase friction when an operator grasps the handle by hand.

22. The heating spoon according to claim 20, characterized in that, a surface of the outer sheath away from the housing is designed with a support post configured such that when the heating spoon is placed on a horizontal surface, the support post and the handle contact a horizontal surface, and the spoon body is away from the horizontal surface.
